(19) United States
(12) Patent Application Publication
(10) Pub. No.: US 2004/0215828 A1
(43) Pub. Date: Oct. 28, 2004

(54) Interconnecting proxy, system and method of interconnecting networks using different protocols

(76) Inventors: Yinghe Li, Shenzhen (CN); Jun Jiao, Shenzhen (CN); Ligang Wang, Shenzhen (CN); Haitao Lin, Shenzhen (CN)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/486,449

(22) PCT Filed: Jun. 3, 2002
(86) PCT No.: PCT/CN02/00386

(51) Int. Cl. G06F 15/16

(52) U.S. Cl. 709/246

(57) ABSTRACT

A system for interoperability between networks utilizing different protocols and method thereof; said system comprises at least two independent IP networks utilizing different protocols as well as an interoperability proxy that performs protocol conversion between those networks. Said interoperability proxy comprises at least a interoperability proxy unit that performs protocol conversion; said interoperability proxy unit comprises a packet-receiving module, a packet-forwarding module, and a protocol-converting module that performs protocol conversion between networks utilizing different protocols. During interoperability between networks utilizing different protocols, the interoperability proxy converts the packet into the protocol that can be identified by the interoperability network, thus it achieves port convergence function and enables the network environment to intercommunicate with networks utilizing different protocols.

### FIELD OF THE INVENTION

The present invention relates to IP (Internet Protocol) communication field, in particular to interoperability equipment and system between networks utilizing different protocols and the interoperability method.

### BACKGROUND OF THE INVENTION

With the development of IP technology, IP services (including IP phone, fax, and multimedia communication) become a highlight of Internet applications. An IP service network usually comprises Gateways (GW), a GK (Gatekeeper), IP supporting transmission network, as well as corresponding NMS, accounting system and operation system. IP gatekeeper is a key device for the entire IP network and is in charge of establishing the IP network and routing management, security management for the IP network, as well as interoperability with other networks. Due to existence of different operation interest entities, the gatekeeper must also implement accounting/settling functions between different networks.

Presently, though most IP phone service equipments are based on ITU H.323 protocol, expansion to the protocol, requirements, and selection of protocol items on equipments of different operators are different. To clarify better, hereinafter we will regard protocols with different expansion items and requirements as different protocols and networks constituted with equipment based on different expanded protocols as networks utilizing different protocols; otherwise the networks are regarded as networks utilizing the same protocol. IP session between networks utilizing the same protocol is relatively simple, i.e., the phone calls are transferred to the gateway through trunk lines, the gateway carries out conversion from Public Switched Telephone Network (PSTN) calls to IP calls, sends route query requests to the gatekeeper, and establishes connections to the counterpart gateway according to route addresses; when the connections are established, the gateway compresses digital signals on the trunk lines and transfers them to the counterpart gateway, which decompresses the digital signals and reverts them to voice signals on trunk lines. Due to the fact that the protocols of those networks are identical, both the transmitting side and the receiving side can identify signaling packets and carry out switching normally.

Interoperability between networks utilizing differnet protocols requires the systems to support different network protocols; at present, direct interoperability between networks utilizing different protocols is usually not practical. Even though equipments from some equipment suppliers support multi-protocols, a specific equipment can only operate with one of the protocols during actual operation, i.e., the equipment can only communicate with networks utilizing the same protocol instead of communicating with networks utilizing other protocols. Such a situation results in severe limitation.

### SUMMARY OF THE INVENTION

In view of above issue, the object of the present invention is to overcome the limitation on interoperability between networks utilizing different protocols in prior art and provide an interoperability proxy supporting various protocols as well as an interoperability system for netowrks utilizing different protocols based on said interoperability proxy and an interoperability method thereof, which support an environment to communicate simultanously with operators' networks utilizing different protocols, beyond the limitation on protocol.

To attain said object, one aspect of the present invention is to provide an interoperability proxy comprising at least an interoperability proxy unit for protocol conversion; said interoperability proxy unit comprises a packet-receiving module, a packet-forwarding module, and a protocol-converting module connected with said packet-receiving module and said packet-forwarding module to convert protocols between local network and counterpart networks.

Wherein, the number of said interoperability proxy units is determined by call capacity and the number of interoperability networks.

Furthermore, the number of said interoperability proxy units matches to that of interoperability networks utilizing different protocols; each of said interoperability proxy units performs packet receiving, conversion, and forwarding between local network and a counterpart network.

Furthermore, for high-capacity interoperability networks utilizing different protocols, a plurality of interoperability proxy units are deployed to perform packet receiving, conversion, and forwarding between local network and counterpart networks.

Another aspect of the present invention is to provide a system that establishes interoperability between networks utilizing different protocols; said system comprises at least two separate IP networks utilizing different protocols, each of which comprises gateways, a gatekeeper, and an interoperability proxy to convert protocols between said IP networks.

Wherein, said interoperability proxy comprises at least an interoperability proxy unit performing protocol conversion; said interoperability proxy unit comprises a packet-receiving module, a packet-forwarding module and a protocol-converting module connected with said packet-receiving module and said packet-forwarding module to perform protocol conversion between different networks.

Wherein, the number of said interoperability proxy units is determined by call capacity and the number of interoperability networks utilizing different protocols.

Furthermore, the number of said interoperability proxy units matches to that of the interoperability networks utilizing different protocols, each of said interoperability proxy units performs packet receiving, conversion, and forwarding between local network and a counterpart network.

Furthermore, for high-capacity networks utilizing different protocols, a plurality of interoperability proxy units are deployed to perform packet receiving, conversion, and forwarding between local network and said counterpart networks.

Another aspect of the present invention is to provide a method for interoperability between network utilizing different protocols, comprising:

a. The calling gateway initiates a call to the interoperability proxy;

b. The interoperability proxy converts the received call establishing packet into the packet complying with called network, and then forwards the packet to the called gateway and queries for routing information in the gatekeeper of called network simultaneously;

c. The gateway of called network receives the packet from the interoperability proxy, and responds with an “Alerting” message and a “Connect” message to the interoperability proxy;

d. The interoperability proxy unit converts the “Alerting” and “Connect” messages into packets complying with the calling network, and then forwards the packets to the calling gateway to achieve call switching.

### BRIEF DESCRIPTION OF THE DRAWINGS

The present invention will be described in further detail with referrence to the following embodiments and the attached drawings.

FIG. 1 is a schematic block diagram of the interoperability proxy according to the present invention;

FIG. 2 is a schematic block diagram of the interoperability proxy unit shown in FIG. 1;

FIG. 3 is a schematic diagram of the interoperability system for networks utilizing different protocols according to the present invention.

### DETAILED DESCRIPTION OF THE EMBODIMENTS

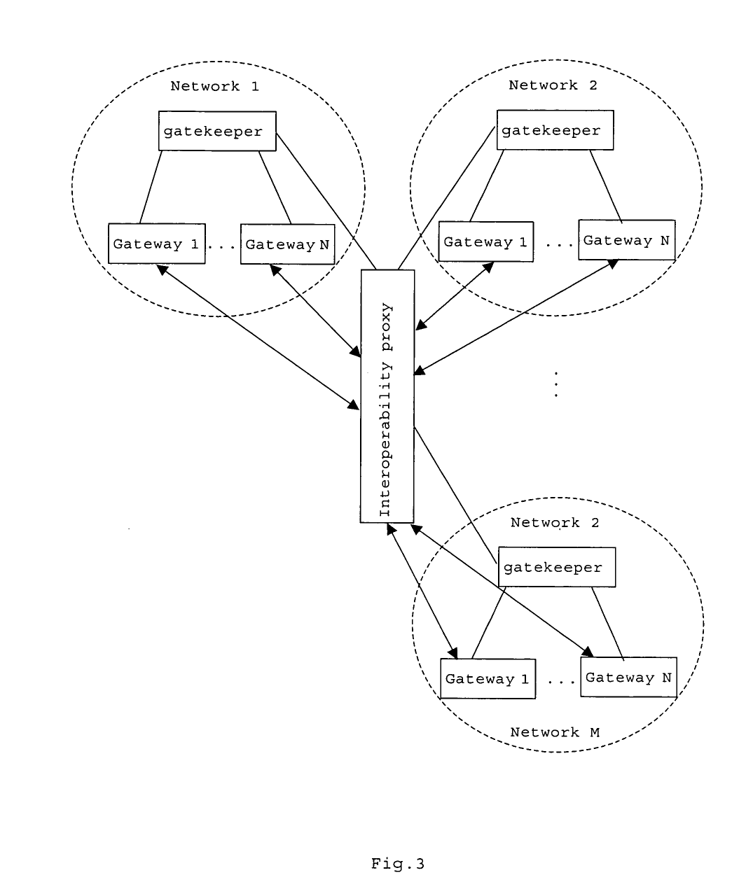

As shown in FIG. 3, Network 1, Network 2, . . . , Network M are different IP networks, each of which has a gatekeeper and a gateway and utilizes the same network protocol in itself; however, the protocols are different between those networks. To clarify better, in the present embodiment, Network 1 is regarded as the local network, and it intercommunicates with Network 2, Network 3, . . . , Network M, all of which are regarded as interoperability networks. The interoperability proxy, as a gateway, registers itself to the gatekeeper of local network and gatekeepers in the interoperability networks, and carries out call packet receiving, protocol conversion, and packet forwarding tasks between those networks utilizing different protocols. Hence, the local network, the interoperability proxy, and at least an interoperability network utilizing a protocol different to that of the local network constitute an IP interoperability system, and the interoperability proxy is the key of said interoperability system.

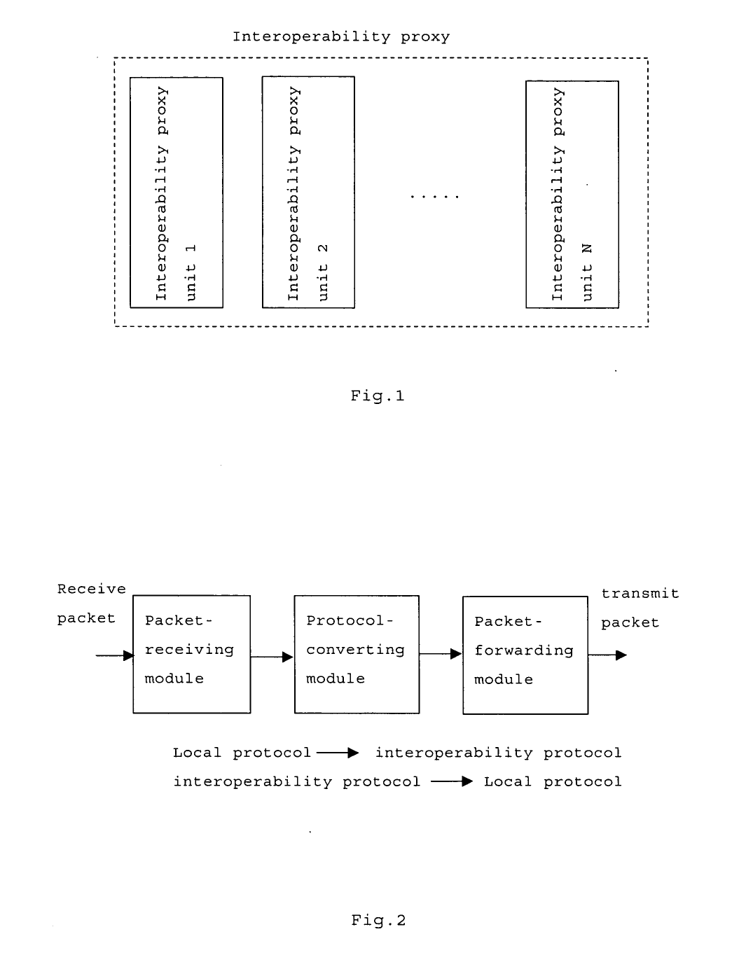

As shown in FIG. 1, the interoperability proxy comprises a set of interoperability proxy units, the number of which may be determined by call capacity and the number of interoperability networks. In actual implementation, an interoperability proxy unit is configured an interoperability protocol and a protocol for local network gateway to achieve protocol conversion between the protocols; therefore, the number of interoperability proxy units matches to that of the interoperability networks. In case the interoperability load to an IP network is heavy, a plurality of interoperability proxy units may be deployed for that IP network. Viewed from the external world, the interoperability proxy is a proxy server or a group of proxy servers that support(s) a plurality of interoperability protocols; thus a gateway configured with a specific protocol may intercommunicate with networks utilizing different protocols.

FIG. 2 is a schematic block diagram of the interoperability proxy unit; each of the interoperability proxy unit comprises a packet-receiving module, a protocol-converting module, and a packet-forwarding module. The packet-receiving module receives H.323 packets sent from the calling gateway, the protocol-converting module carries out protocol conversion for the packets, and the packet-forwarding module forwards the converted packet to the called gateway.

Hereunder we describe the interoperability method between networks utilizing different protocols (i.e., local network and interoperability network) with reference to above interoperability system, in which the local network serves as the calling party and the interoperability network serves as the called party.

First, the calling gateway initiates an IP call to the interoperability proxy. In the present embodiment, the local network gateway sends the call setup packet (Setup packet) to the interoperability proxy unit that supports protocol of the called party in the interoperability proxy;

then, the corresponding interoperability proxy unit converts the received establishing packet into the packet complying with the called network, and forwards the converted packet to the called gateway and queries routing information to the gatekeeper of called network;

The called gateway receives the packet sent from the interoperability proxy unit; owing to the fact that the packet has been converted by the interoperability proxy into the protocol complying with the called party, the called gateway can identify the received packet; The called gateway responds an “Alerting” message and a “Connect” message to the interoperability proxy according to the call setup packet received;

The interoperability proxy unit converts the “Alerting” and “Connect” messages into the packet complying with the calling network, and then forwards the packets to the calling gateway to achieve call switching.

The case in which an interoperability network calls the local network is identical to above case.

Said steps are common for interoperability between networks utilizing different protocols; if there are many interoperability networks, the gatekeeper of the calling party will performs routing selection, including select corresponding interoperability proxy units). When the calling party initiates a call, the gatekeeper of the calling party performs routing selection according to the called number to choose the address of the called gateway. The same called number may correspond to a plurality of interoperability networks, such as in the case where a plurality of operators operates services in the same region. In that case, the gatekeeper will choose an operator according to appropriate policies (e.g., pricing, delay, and performance), i.e., it achieves switching through the interoperability network of that operator. In case said called number only corresponds to one operator, only one interoperability network is available to achieve switching. First, the call is sent to the corresponding interoperability proxy unit; in case that interoperability proxy unit only corresponds to one interoperability network, the call will be routed to that interoperability network, and the gatekeeper will determine the target interoperability proxy unit according to the priority configuration of those interoperability proxy units.

### INDUSTRIAL APPLICABILITY

Owing that the present invention forwards call packets via the interoperability proxy, it achieves port convergence function and screens protocol discrepancies between the gateways. Thus the local network gateway can intercommunicate with networks utilizing different protocols simultaneously.

1. An interoperability proxy, comprising at least an interoperability proxy unit for protocol conversion; said interoperability proxy unit comprising a packet-receiving module, a packet-forwarding module, and a protocol-converting module connected with said packet-receiving module and said packet-forwarding module to convert protocols between local network and counterpart networks.

2. The interoperability proxy according to claim 1, wherein the number of said interoperability proxy units is determined by call capacity and the number of interoperability networks.

3. The interoperability proxy according to claim 1 or 2, wherein the number of said interoperability proxy units matches that of interoperability networks utilizing different protocols, each of said interoperability proxy units performing packet receiving, conversion, and forwarding between local network and a counterpart network.

4. The interoperability proxy according to claim 1 or 2, wherein for high-capacity interoperability networks utilizing different protocols, a plurality of interoperability proxy units are deployed to perform packet receiving, conversion, and forwarding between local network and counterpart networks.

5. A system of establishing interoperability between networks utilizing different protocols, comprising at least two separate IP networks utilizing different protocols, each of which comprises gateways, a gatekeeper, and further comprises an interoperability proxy to convert protocols between said IP networks.

6. The system according to claim 5, wherein said interoperability proxy comprises at least an interoperability proxy unit performing protocol conversion; said interoperability proxy unit comprising a packet-receiving module, a packet-forwarding module and a protocol-converting module connected to said packet-receiving module and said packet-forwarding module to perform protocol conversion between different networks.

7. The system according to claim 6, wherein the number of said interoperability proxy units is determined by call capacity and the number of interoperability networks utilizing different protocols.

8. The system according to claim 6 or 7, wherein the number of said interoperability proxy units matches that of the interoperability networks utilizing different protocols, each of said interoperability proxy units performing packet receiving, conversion, and forwarding between local network and a counterpart network.

9. The system according to claim 6 or 7, wherein for high-capacity networks utilizing different protocols, a plurality of interoperability proxy units are deployed to perform packet receiving, conversion, and forwarding between local network and said counterpart networks.

10. A method for interoperating between networks utilizng different protocols, comprising:
initiating a call to an interoperability proxy with a calling gateway;
converting a received call establishing packet into a packet complying with called a network with the interoperability proxy;
substantially simultaneously forwarding the packet to the called gateway and querying for routing information in a gatekeeper of the called network;
generating an alerting message and a connect message to the interoperability proxy with the gateway;
converting the alerting and connect messages into the packet complying with the calling network with the interoperability proxy unit; and
forwarding the packets to the calling gateway to achieve call switching.
